(19) United States
(12) Patent Application Publication
(10) Pub. No.: US 2023/0063834 A1
(43) Pub. Date: Mar. 2, 2023

(54) REDOX FLOW BATTERY

(71) Applicant: Panasonic Intellectual Property Management Co., Ltd., Osaka (JP)

(72) Inventor: HONAMI SAKO, Osaka (JP)

(21) Appl. No.: 18/053,388

(22) Filed: Nov. 8, 2022

Related U.S. Application Data
(63) Continuation of application No. PCT/JP2021/002514, filed on Jan. 25, 2021.

(30) Foreign Application Priority Data
May 28, 2020 (JP) 2020-093577

(51) Int. Cl. H01M 8/18; H01M 8/1023; H01M 8/1032

(52) U.S. Cl. CPC H01M 8/188; H01M 8/1023; H01M 8/1032

(57) ABSTRACT

A redox flow battery includes: a negative electrode; a positive electrode; a first liquid which is in contact with the negative electrode, and which contains a first nonaqueous solvent, a first redox species, and metal ions; a second liquid which is in contact with the positive electrode, and which contains a second nonaqueous solvent, a second redox species, and metal ions; and a metal ion-conducting membrane disposed between the first liquid and the second liquid. The metal ion-conducting membrane contains an organic polymer containing a plurality of hydroxy groups. The organic polymer contains a group formed by substituting at least a portion of the hydroxy groups with a metal sulfonate.

### BACKGROUND

### 1. Technical Field

The present disclosure relates to a redox flow battery.

### 2. Description of the Related Art

Japanese Unexamined Pat. Application Publication (Translation of PCT Application) No. 2014-524124 discloses a redox flow battery system including an energy reservoir containing a redox species.

International Publication No. 2016/208123 discloses a redox flow battery in which a redox species is used.

Japanese Unexamined Pat. Application Publication No. 62-226580 discloses a redox flow battery including a porous separation membrane made of an organic polymer.

### SUMMARY

One non-limiting and exemplary embodiment provides a redox flow battery in which the crossover of redox species is suppressed.

In one general aspect, the techniques disclosed here feature a redox flow battery including: a negative electrode; a positive electrode; a first liquid which is in contact with the negative electrode, and which contains a first nonaqueous solvent, a first redox species, and metal ions; a second liquid which is in contact with the positive electrode, and which contains a second nonaqueous solvent, a second redox species, and metal ions; and a metal ion-conducting membrane disposed between the first liquid and the second liquid. The metal ion-conducting membrane contains an organic polymer containing a plurality of hydroxy groups. The organic polymer contains a group formed by substituting at least a portion of the hydroxy groups with a metal sulfonate.

According to the present disclosure, a redox flow battery in which the crossover of redox species is suppressed can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view showing the schematic configuration of a redox flow battery according to the embodiment;

FIG. 2 is a graph showing the open circuit voltage of an electrochemical cell according to Example 1;

FIG. 3 is a graph showing the open circuit voltage of an electrochemical cell according to Example 2;

FIG. 4 is a graph showing the open circuit voltage of an electrochemical cell according to Comparative Example 1;

FIG. 5 is a graph showing a charge/discharge profile according to Example 1; and

FIG. 6 is a graph showing the open circuit voltage of an electrochemical cell according to Comparative Example 2.

### DETAILED DESCRIPTIONS

### Underlying Knowledge Forming Basis of the Present Disclosure

Inorganic solid electrolytes are difficult to form into a thin film, and films having an increased thickness are subject to increased polarization during charge and discharge. On the other hand, organic polymer solid electrolytes have low ionic conductivity and low resistance to electrolyte solutions and are dissolved in solvents and cause redox species to migrate to a counter electrode side. The inventor has intensively investigated these problems and, as a result, has conceived a redox flow battery according to the present disclosure.

### Summary of Aspect of Present Disclosure

A redox flow battery according to a first aspect of the present disclosure includes:
a negative electrode;
a positive electrode;
a first liquid which is in contact with the negative electrode, and which contains a first nonaqueous solvent, a first redox species, and metal ions;
a second liquid which is in contact with the positive electrode, and which contains a second nonaqueous solvent, a second redox species, and metal ions; and
a metal ion-conducting membrane disposed between the first liquid and the second liquid.

The metal ion-conducting membrane contains an organic polymer containing a plurality of hydroxy groups.

The organic polymer contains a group formed by substituting at least a portion of the hydroxy groups with a metal sulfonate.

According to the first aspect, the metal ion-conducting membrane has a low affinity for nonaqueous solvents and therefore passage of the first redox species through the metal ion-conducting membrane can be suppressed. This enables the crossover of the first redox species from the first liquid to the second liquid to be suppressed. Therefore, a redox flow battery in which high capacity can be maintained over a long period of time can be achieved.

In a second aspect of the present disclosure, for example, in the redox flow battery according to the first aspect, the organic polymer may be cellulose or polyvinyl alcohol.

In a third aspect of the present disclosure, for example, in the redox flow battery according to the first aspect, the organic polymer may be cellulose.

According to the second and third aspects, the metal ion-conducting membrane in which the organic polymer is cellulose or polyvinyl alcohol has a low affinity for nonaqueous solvents and therefore passage of the first redox species can be suppressed. This enables the crossover of the first redox species from the first liquid to the second liquid to be suppressed. Therefore, a redox flow battery in which high capacity can be maintained over a long period of time can be achieved.

In a fourth aspect of the present disclosure, the metal sulfonate may be lithium sulfonate or sodium sulfonate.

In a fifth aspect of the present disclosure, for example, in the redox flow battery according to the first to fourth aspects, the metal ions may include at least one selected from the group consisting of lithium ions, sodium ions, magnesium ions, and aluminum ions.

In a sixth aspect of the present disclosure, for example, the redox flow battery according to the first to fifth aspects may further include a negative electrode active material having at least a portion which is in contact with the first liquid, the first redox species may be an aromatic compound, the metal ions may be lithium ions, the first liquid may dissolve lithium, the negative electrode active material may contain a substance having a property of storing and releasing the lithium ions, a potential of the first liquid may be less than or equal to 0.5 V vs. Li⁺/Li, and the first redox species may be oxidized or reduced by the negative electrode and may be oxidized or reduced by the negative electrode active material.

In a seventh aspect of the present disclosure, for example, in the redox flow battery according to the sixth aspect, the aromatic compound may include at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil.

In an eighth aspect of the present disclosure, for example, the redox flow battery according to any one of the first to seventh aspects may further include a positive electrode active material having at least a portion which is in contact with the second liquid and the second redox species may be oxidized or reduced by the positive electrode and may be oxidized or reduced by the positive electrode active material.

In a ninth aspect of the present disclosure, for example, in the redox flow battery according to the first to eighth aspects, the second redox species may include at least one selected from the group consisting of tetrathiafulvalene, metallocene compounds, triphenylamine, and derivatives thereof.

In a tenth aspect of the present disclosure, for example, in the redox flow battery according to the first to ninth aspects, each of the first nonaqueous solvent and the second nonaqueous solvent may contain at least one of carbonate group-containing compounds or ether bond-containing compounds.

In an eleventh aspect of the present disclosure, for example, in the redox flow battery according to the tenth aspect, the carbonate group-containing compounds may include at least one selected from the group consisting of propylene carbonate, ethylene carbonate, dimethyl carbonate, ethyl methyl carbonate, and diethyl carbonate.

In a twelfth aspect of the present disclosure, for example, in the redox flow battery according to the tenth or eleventh aspect, the ether bond-containing compounds may include at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane.

According to the fourth to twelfth aspects, the redox flow battery exhibits high discharge voltage and therefore has high volume energy density.

Embodiments of the present disclosure are described below with reference to the accompanying drawings. The present disclosure is not limited to the embodiments below. Embodiments

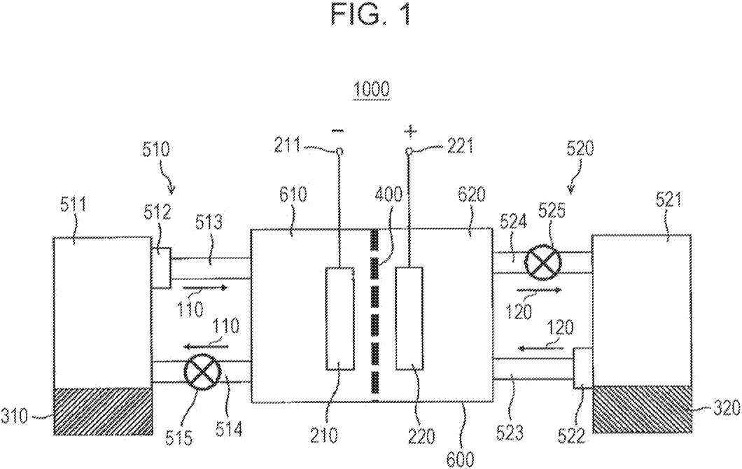

FIG. 1 is a schematic view showing the schematic configuration of a redox flow battery 1000 according to the embodiment. As shown in FIG. 1, the redox flow battery 1000 includes a negative electrode 210, a positive electrode 220, a first liquid 110, a second liquid 120, and a metal ion-conducting membrane 400. The redox flow battery 1000 may further include a negative electrode active material 310. The first liquid 110 contains a first nonaqueous solvent, a first redox species, and metal ions. The first liquid 110 is in contact with, for example, each of the negative electrode 210 and the negative electrode active material 310. Each of the negative electrode 210 and the negative electrode active material 310 may be immersed in the first liquid 110. At least a portion of the negative electrode 210 is in contact with the first liquid 110. The second liquid 120 contains a second nonaqueous solvent, a second redox species, and metal ions. The redox flow battery 1000 may further include a positive electrode active material 320. The second liquid 120 is in contact with, for example, the positive electrode 220 and the positive electrode active material 320. Each of the positive electrode 220 and the positive electrode active material 320 may be immersed in the second liquid 120. At least a portion of the positive electrode 220 is in contact with the second liquid 120. The metal ion-conducting membrane 400 is disposed between the first liquid 110 and the second liquid 120 and isolates the first liquid 110 and the second liquid 120.

As shown in FIG. 1, the metal ion-conducting membrane 400, which is included in the redox flow battery 1000 according to the present embodiment, has a first surface and a second surface as principal surfaces; the first surface is in contact with the first liquid 110; and the second surface is in contact with the second liquid 120.

The metal ion-conducting membrane 400 contains an organic polymer containing a plurality of hydroxy groups. The organic polymer contains a group formed by substituting at least a portion of the hydroxy groups with a metal sulfonate. Since the metal ion-conducting membrane 400 has a site at which at least a portion of the hydroxy groups is substituted with the metal sulfonate, metal ions can move through the metal ion-conducting membrane 400. Since the metal ion-conducting membrane 400 contains the organic polymer containing the hydroxy groups, crossover can be suppressed over a long period of time. In the specification, the term “crossover” means that the first redox species moves from the first liquid 110 to the second liquid 120 and the second redox species moves from the second liquid 120 to the first liquid 110. Furthermore, the metal ion-conducting membrane 400 isolates the first liquid 110 and the second liquid 120 from each other.

The shape of the metal ion-conducting membrane 400 is, for example, a plate shape. The metal ion-conducting membrane 400 may have, for example, openings in the first surface of the metal ion-conducting membrane 400 that is in contact with the first liquid 110 and in the second surface of the metal ion-conducting membrane 400 that is in contact with the second liquid 120.

In a case where a glass electrolyte having metal ion conductivity is used as a metal ion-conducting membrane of a nonaqueous redox flow battery and is used in combination with a negative electrode electrolyte with low potential, an element, such as titanium, forming a portion of the glass electrolyte is reduced and the glass electrolyte is altered in some cases. Therefore, it is difficult to extend the life of the nonaqueous redox flow battery in some cases. However, when the metal ion-conducting membrane 400 contains the organic polymer containing the hydroxy groups, the alteration of the metal ion-conducting membrane 400 due to a negative electrode electrolyte with low potential is suppressed. Therefore, according to the metal ion-conducting membrane 400, the redox flow battery 1000 which has long life can potentially be achieved.

In a case where a ceramic electrolyte having metal ion conductivity is used as a metal ion-conducting membrane of a nonaqueous redox flow battery, a large current is locally generated in the vicinity of a grain boundary and a dendrite occurs along the grain boundary in some cases. Furthermore, the ionic conductivity of the ceramic electrolyte itself is low. Therefore, it is difficult to charge or discharge this nonaqueous redox flow battery at high current density in some cases. However, when the metal ion-conducting membrane 400 contains the organic polymer as a major component, the organic polymer is amorphous and has no grain boundary. Therefore, no large current is locally generated and a dendrite in the metal ion-conducting membrane 400 is suppressed from occurring. Therefore, according to the metal ion-conducting membrane 400, the redox flow battery 1000 which can be charged or discharged at high current density can potentially be achieved. The term “major component” refers to a component which is most contained in the form of an organic polymer on a mass basis and the content thereof is, for example, greater than or equal to 50% by mass.

In a case where the first redox species used is an aromatic compound and lithium is dissolved in the first liquid 110 as described below, the first liquid 110 exhibits a notably low potential of less than or equal to 0.5 V vs. Li⁺/Li in some cases. In this case, the organic polymer contained in the metal ion-conducting membrane 400 may be one that does not react with the first liquid 110, which has high reducing power. Examples of the organic polymer include organic polymers containing cellulose, polyvinyl alcohol, or the like as a major component.

The metal ion-conducting membrane 400 includes an organic polymer containing a group formed by substituting at least a portion of a plurality of hydroxy groups with a metal sulfonate. In other words, the organic polymer containing the hydroxy groups contains at least one metal sulfonate group. In this case, when the metal ion-conducting membrane 400 is in contact with the first liquid 110 and the second liquid 120, the metal ions contained in the first liquid 110 and the second liquid 120 move while being substituted with metal ions of metal sulfonate portions. Furthermore, a main skeleton, such as cellulose, is unlikely to cause a side reaction with the first liquid 110 and the second liquid 120, which each contain a nonaqueous solvent. Therefore, the redox flow battery 1000 according to the present embodiment allows metal ions to pass through the metal ion-conducting membrane 400 and enables the crossover of the first redox species to be suppressed. This expands options for the first liquid 110 that can be used and the first redox species dissolved in the first liquid 110. Thus, the control range of the charge potential and discharge potential of the redox flow battery 1000 is extended, thereby enabling the charge capacity thereof to be increased.

The metal ion-conducting membrane 400 contains the organic polymer containing the hydroxy groups. The number of the hydroxy groups is not particularly limited and may be greater than or equal to two. The organic polymer containing the hydroxy groups contains the hydroxy groups and is therefore excellent in separation performance between the first liquid 110, which contains the first nonaqueous solvent, and the second liquid 120, which contains the second nonaqueous solvent. The organic polymer containing the hydroxy groups may be a hydrophilic organic polymer containing a plurality of hydroxy groups. The organic polymer containing the hydroxy groups may be, for example, cellulose or polyvinyl alcohol. The cellulose may be natural cellulose or synthetic cellulose. The natural cellulose may be a natural polymer formed by linearly polymerizing β-glucose molecules by glycoside bonding or may be regenerated cellulose of the natural polymer. The cellulose may be, for example, hydroxypropylcellulose, hydroxypropylmethylcellulose, or the like. This allows the metal ion-conducting membrane 400 to exhibit high durability to the high reducing power of electrolyte solutions.

The hydrophilic organic polymer containing the hydroxy groups may be a hydrophilic organic polymer having a main chain which is an aliphatic hydrocarbon and a side chain which has hydroxy groups. This allows the metal ion-conducting membrane 400 to exhibit high durability to the high reducing power of electrolyte solutions. Therefore, the charge/discharge capacity of the redox flow battery 1000 can be maintained over a long period of time. In the present disclosure, durability to electrolyte solutions is also referred to as “electrolyte solution resistance”. When the organic polymer containing the hydroxy groups exhibits electrolyte solution resistance, the organic polymer containing the hydroxy groups may be one formed by modifying a polymer, such as a polyolefin, with hydroxy groups. The polyolefin may be polyethylene, polypropylene, or the like. The organic polymer containing the hydroxy groups may be, for example, an ethylene-vinyl alcohol copolymer. A reaction in which a hydroxy group is substituted with the metal sulfonate is severe. If too many hydroxy groups are substituted, the film itself may break, and as a result, a self-supporting film may not be available. Therefore, it may be that only a portion of a plurality of hydroxy groups is substituted with the metal sulfonate. The molecular weight cutoff of the regenerated cellulose may be, for example, greater than or equal to 100 Da or greater than or equal to 1,000 Da. The molecular weight cutoff of the regenerated cellulose may be, for example, less than or equal to 100,000 Da or less than or equal to 50,000 Da.

A group substituted with the metal sulfonate has a structure represented by the formula -OSO₃M (where M represents a metal atom). The metal atom represented by M may be sodium or lithium. The metal sulfonate may be lithium sulfonate or sodium sulfonate from the viewpoint of exhibiting high metal ion conductivity.

The thickness of the metal ion-conducting membrane 400 is not particularly limited as long as the metal ion-conducting membrane 400 has metal ion conductivity sufficient for the operation of the redox flow battery 1000 and the mechanical strength of the metal ion-conducting membrane 400 can be ensured. The thickness of the metal ion-conducting membrane 400 may be greater than or equal to 10 µm and less than or equal to 1 mm, greater than or equal to 10 µm and less than or equal to 500 µm, or greater than or equal to 50 µm and less than or equal to 200 µm.

A method for manufacturing the metal ion-conducting membrane 400 is not particularly limited as long as the hydroxy groups contained in the organic polymer are substituted with the metal sulfonate and the metal ion-conducting membrane 400 is not dissolved or a reaction, such as degradation, does not occur when the metal ion-conducting membrane 400 is in contact with the first liquid and the second liquid. The method for manufacturing the metal ion-conducting membrane 400 is, for example, a method in which the organic polymer containing the hydroxy groups comes into contact with an organic solvent solution containing sulfur trioxide and pyridine.

According to the above configuration, the redox flow battery 1000 which has a large charge capacity and of which the charge/discharge capacity is maintained over a long period of time can be achieved.

In the redox flow battery 1000 according to the present embodiment, the metal ions may include, for example, at least one selected from the group consisting of lithium ions, sodium ions, and aluminum ions.

The first redox species includes, for example, an organic compound that dissolves lithium into cations. The organic compound may be an aromatic compound or a condensed aromatic compound. The first redox species may include at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil. The first redox species may be a metallocene compound, such as ferrocene. The molecular weight of the first redox species is not particularly limited and may be greater than or equal to 100 and less than or equal to 500 or greater than or equal to 100 and less than or equal to 300.

The potential of the first liquid 110 may be less than or equal to 0.5 V vs. Li⁺/Li. In this case, the metal ion-conducting membrane 400 may be one that does not react at less than or equal to 0.5 V vs. Li⁺/Li.

In the redox flow battery 1000 according to the present embodiment, each of the first nonaqueous solvent and the second nonaqueous solvent may contain a carbonate group-containing compound or an ether bond-containing compound.

The carbonate group-containing compound used may be, for example, at least one selected from the group consisting of propylene carbonate (PC), ethylene carbonate (EC), dimethyl carbonate (DMC), ethyl methyl carbonate (EMC), and diethyl carbonate (DEC).

The ether bond-containing compound used may be, for example, at least one selected from the group consisting of dimethoxyethane, diethoxyethane, dibutoxyethane, diglyme (diethylene glycol dimethyl ether), triglyme (triethylene glycol dimethyl ether), tetraglyme (tetraethylene glycol dimethyl ether), polyethylene glycol dialkyl ethers, tetrahydrofuran, 2-methyltetrahydrofuran, 2,5-dimethyltetrahydrofuran, 1,3-dioxolane, and 4-methyl-1,3-dioxolane.

In the redox flow battery 1000 according to the present embodiment, the first liquid 110 may be an electrolyte solution containing the above-mentioned first nonaqueous solvent and an electrolyte. The electrolyte may be at least one salt selected from the group consisting of LiBF₄, LiPF₆, LiTFSI (lithium bis(trifluoromethanesulfonyl)imide), LiFSI (lithium bis(fluorosulfonyl)imide), LiCF₃SO₃, LiClO₄, NaBF₄, NaPF₆, NaTFSI, NaFSI, NaCF₃SO₃, NaClO₄, Mg(BF₄)₂, Mg(PF₆)₂, Mg(TFSI)₂, Mg(FSI)₂, Mg(CF₃SO₃)₂, Mg(ClO₄)₂, AlCl₃, AlBr₃, and Al(TFSI)₃. The first nonaqueous solvent may have a high dielectric constant, the reactivity of the first nonaqueous solvent with the metal ions may be low, and the potential window of the first nonaqueous solvent may be less than or equal to about 4 V.

In the redox flow battery 1000 according to the present embodiment, the negative electrode 210 may be insoluble in the first liquid 110, which is in contact therewith. Material of the negative electrode 210 may be material stable against electrochemical reactions. Examples of material used to form the negative electrode 210 include stainless steel, iron, copper, nickel, and carbon.

The negative electrode 210 may have a structure with an increased surface area. Examples of such a structure with an increased surface area include meshes, nonwoven fabrics, surface-roughened plates, and sintered porous bodies. When the negative electrode 210 has this structure, the negative electrode 210 has a large specific surface area. Therefore, the oxidation reaction or reduction reaction of the first redox species in the negative electrode 210 proceeds readily.

In the redox flow battery 1000 according to the present embodiment, at least a portion of the negative electrode active material 310 is in contact with the first liquid 110. The negative electrode active material 310 is insoluble in, for example, the first liquid 110. The negative electrode active material 310 can reversibly store or release the metal ions. Material of the negative electrode active material 310 is metal, a metal oxide, carbon, silicon, or the like. The metal is lithium, sodium, magnesium, aluminum, tin, or the like. The metal oxide is titanium oxide or the like. When the first redox species is the aromatic compound and lithium is dissolved in the first liquid 110, the negative electrode active material 310 may contain at least one selected from the group consisting of carbon, silicon, aluminum, and tin.

The shape of the negative electrode active material 310 is not particularly limited and the negative electrode active material 310 may be granular, powdery, or pellet shaped. The negative electrode active material 310 may be bound with a binder. Examples of the binder include resins such as polyvinylidene fluoride, polypropylene, polyethylene, and polyimide.

When the redox flow battery 1000 includes the negative electrode active material 310, the charge/discharge capacity of the redox flow battery 1000 does not depend on the solubility of the first redox species but depends on the capacity of the negative electrode active material 310. Therefore, the redox flow battery 1000 which has high energy density can be readily achieved.

In the redox flow battery 1000 according to the present embodiment, the positive electrode 220 may be insoluble in the second liquid 120, which is in contact therewith. Material of the positive electrode 220 may be material stable against electrochemical reactions. For example, material used to form the positive electrode 220 is material exemplified for the negative electrode 210 or the like. The negative electrode 210 and the positive electrode 220 may be made of the same material or different materials.

When the redox flow battery 1000 includes the positive electrode active material 320, the second redox species functions as a positive electrode mediator. The second redox species is dissolved in, for example, the second liquid 120. The second redox species is oxidized or reduced by the positive electrode 220 and is oxidized or reduced by the positive electrode active material 320. When the redox flow battery 1000 includes no positive electrode active material 320, the second redox species functions as an active material oxidized or reduced by the positive electrode 220 only.

In the redox flow battery 1000 according to the present embodiment, the second redox species may be a heterocyclic compound, such as tetrathiafulvalene, a derivative thereof, carbazole, a derivative thereof, triphenylamine, a derivative thereof, a bipyridyl derivative, a thiophene derivative, a thianthrene derivative, or phenanthroline, or may be at least one selected from the group consisting of tetrathiafulvalene, triphenylamine, and derivatives thereof. The second redox species may be, for example, a metallocene compound, such as ferrocene or titanocene. The second redox species used may be a combination of greater than or equal to two of these compounds as required.

The size of the second redox species solvated with the second nonaqueous solvent can be calculated by, for example, a first-principles calculation using the density functional method B3LYP/6-31G as with the first redox species. In the specification, the size of the second redox species solvated with the second nonaqueous solvent means, for example, the diameter of the minimum sphere that can enclose the second redox species solvated with the second nonaqueous solvent. The coordination state and coordination number of the second nonaqueous solvent for the second redox species can be estimated from, for example, results of NMR measurement of the second liquid 120.

In the redox flow battery 1000 according to the present embodiment, the number of options for the first liquid 110, the first redox species, the second liquid 120, and the second redox species is large. Therefore, the control range of the charge potential and discharge potential of the redox flow battery 1000 is wide and the charge capacity of the redox flow battery 1000 can be readily increased. Furthermore, the first liquid 110 and the second liquid 120 are hardly mixed due to the metal ion-conducting membrane 400. Therefore, charge/discharge characteristics of the redox flow battery 1000 can be maintained over a long period of time.

The positive electrode 220 may have a structure with an increased surface area. Examples of such a structure with an increased surface area include meshes, nonwoven fabrics, surface-roughened plates, and sintered porous bodies. When the positive electrode 220 has this structure, the positive electrode 220 has a large specific surface area. Therefore, the oxidation reaction or reduction reaction of the second redox species in the positive electrode 220 proceeds readily.

The redox flow battery 1000 may further include the positive electrode active material 320 as described above. At least a portion of the positive electrode active material 320 is in contact with the second liquid 120. The positive electrode active material 320 is insoluble in, for example, the second liquid 120. The positive electrode active material 320 can reversibly store or release the metal ions. Examples of the positive electrode active material 320 include metal oxides such as lithium iron phosphate, LiCoO₂ (LCO), LiMn₂O₄ (LMO), and lithium-nickel-cobalt-aluminum composite oxide (NCA).

The shape of the positive electrode active material 320 is not particularly limited and the positive electrode active material 320 may be granular, powdery, or pellet shaped. The positive electrode active material 320 may be bound with a binder. Examples of the binder include resins such as polyvinylidene fluoride, polypropylene, polyethylene, and polyimide.

When the redox flow battery 1000 includes the negative electrode active material 310 and the positive electrode active material 320, the charge/discharge capacity of the redox flow battery 1000 does not depend on the solubility of the first or second redox species but depends on the capacity of the negative electrode active material 310 and the positive electrode active material 320. Therefore, the redox flow battery 1000 which has high energy density can be readily achieved.

The redox flow battery 1000 may further include an electrochemical reaction section 600, a negative electrode terminal 211, and a positive electrode terminal 221. The electrochemical reaction section 600 includes a negative electrode compartment 610 and a positive electrode compartment 620. The metal ion-conducting membrane 400 is disposed in the electrochemical reaction section 600. The metal ion-conducting membrane 400 separates an inner portion of the electrochemical reaction section 600 into the negative electrode compartment 610 and the positive electrode compartment 620.

The negative electrode compartment 610 contains the negative electrode 210 and the first liquid 110. In an inner portion of the negative electrode compartment 610, the negative electrode 210 is in contact with the first liquid 110. The positive electrode compartment 620 contains the positive electrode 220 and the second liquid 120. In an inner portion of the positive electrode compartment 620, the positive electrode 220 is in contact with the second liquid 120.

The negative electrode terminal 211 is electrically connected to the negative electrode 210. The positive electrode terminal 221 is electrically connected to the positive electrode 220. The negative electrode terminal 211 and the positive electrode terminal 221 are electrically connected to, for example, a charge-discharge device. The charge-discharge device can apply a voltage to the redox flow battery 1000 through the negative electrode terminal 211 and the positive electrode terminal 221. The charge-discharge device can draw electricity from the redox flow battery 1000 through the negative electrode terminal 211 and the positive electrode terminal 221.

The redox flow battery 1000 may further include a first circulation mechanism 510 and a second circulation mechanism 520. The first circulation mechanism 510 includes a first storage section 511, a first filter 512, a pipe 513, a pipe 514, and a pump 515. The first storage section 511 stores the negative electrode active material 310 and the first liquid 110. In an inner portion of the first storage section 511, the negative electrode active material 310 is in contact with the first liquid 110. For example, the first liquid 110 is present in interstices of the negative electrode active material 310. The first storage section 511 is, for example, a tank.

The first filter 512 is disposed at an outlet of the first storage section 511. The first filter 512 may be disposed at an inlet of the first storage section 511 or may be disposed at an inlet or outlet of the negative electrode compartment 610. The first filter 512 may be disposed in the pipe 513 as described below. The first filter 512 allows the first liquid 110 to pass therethrough and suppresses passage of the negative electrode active material 310. When the negative electrode active material 310 is granular, the first filter 512 has, for example, pores smaller than the particle size of the negative electrode active material 310. Material of the first filter 512 is not particularly limited as long as the material of the first filter 512 is almost unreactive with the negative electrode active material 310 and the first liquid 110. Examples of the first filter 512 include glass fiber filter paper, polypropylene nonwoven fabrics, polyethylene nonwoven fabrics, polyethylene separators, polypropylene separators, polyimide separators, separators with a polyethylene/polypropylene two-layer structure, separators with a polypropylene/polyethylene/polypropylene three-layer structure, and metal meshes unreactive with metallic lithium. According to the first filter 512, leakage of the negative electrode active material 310 from the first storage section 511 can be suppressed. This allows the negative electrode active material 310 to remain in the first storage section 511. In the redox flow battery 1000, the negative electrode active material 310 itself does not circulate. Therefore, an inner portion of the pipe 513 or the like is unlikely to be clogged with the negative electrode active material 310. According to the first filter 512, resistance loss due to leakage of the negative electrode active material 310 into the negative electrode compartment 610 can also be suppressed from occurring.

The pipe 513 is connected to, for example, the outlet of the first storage section 511 with the first filter 512 therebetween. The pipe 513 has an end connected to the outlet of the first storage section 511 and another end connected to the inlet of the negative electrode compartment 610. The first liquid 110 is fed to the negative electrode compartment 610 from the first storage section 511 through the pipe 513.

The pipe 514 has an end connected to the outlet of the negative electrode compartment 610 and another end connected to the inlet of the first storage section 511. The first liquid 110 is fed to the first storage section 511 from the negative electrode compartment 610 through the pipe 514.

The pump 515 is disposed in the pipe 514. The pump 515 may be disposed in the pipe 513. The pump 515 pressurizes, for example, the first liquid 110. The flow rate of the first liquid 110 can be regulated by controlling the pump 515. The circulation of the first liquid 110 can be started or stopped with the pump 515. Incidentally, the flow rate of the first liquid 110 can be regulated with a member other than a pump. The member is, for example, a valve.

As described above, the first circulation mechanism 510 can circulate the first liquid 110 between the negative electrode compartment 610 and the first storage section 511. According to the first circulation mechanism 510, the amount of the first liquid 110 that is in contact with the negative electrode active material 310 can be readily increased. The contact time between the first liquid 110 and the negative electrode active material 310 can also be increased. Therefore, the oxidation reaction and reduction reaction of the first redox species with the negative electrode active material 310 can be efficiently carried out.

The second circulation mechanism 520 includes a second storage section 521, a second filter 522, a pipe 523, a pipe 524, and a pump 525. The second storage section 521 stores the positive electrode active material 320 and the second liquid 120. In an inner portion of the second storage section 521, the positive electrode active material 320 is in contact with the second liquid 120. The second liquid 120 is present in, for example, interstices of the positive electrode active material 320. The second storage section 521 is, for example, a tank.

The second filter 522 is disposed at an outlet of the second storage section 521. The second filter 522 may be disposed at an inlet of the second storage section 521 or may be disposed at an inlet or outlet of the positive electrode compartment 620. The second filter 522 may be disposed in the pipe 523 as described below. The second filter 522 allows the second liquid 120 to pass therethrough and suppresses passage of the positive electrode active material 320. When the positive electrode active material 320 is granular, the second filter 522 has, for example, pores smaller than the particle size of the positive electrode active material 320. Material of the second filter 522 is not particularly limited as long as the material of the second filter 522 is almost unreactive with the positive electrode active material 320 and the second liquid 120. Examples of the second filter 522 include glass fiber filter paper, polypropylene nonwoven fabrics, polyethylene nonwoven fabrics, and metal meshes unreactive with metallic lithium. According to the second filter 522, leakage of the positive electrode active material 320 from the second storage section 521 can be suppressed. This allows the positive electrode active material 320 to remain in the second storage section 521. In the redox flow battery 1000, the positive electrode active material 320 itself does not circulate. Therefore, an inner portion of the pipe 523 or the like is unlikely to be clogged with the positive electrode active material 320. According to the second filter 522, resistance loss due to leakage of the positive electrode active material 320 into the positive electrode compartment 620 can also be suppressed from occurring.

The pipe 523 is connected to, for example, the outlet of the second storage section 521 with the second filter 522 therebetween. The pipe 523 has an end connected to the outlet of the second storage section 521 and another end connected to the inlet of the positive electrode compartment 620. The second liquid 120 is fed to the positive electrode compartment 620 from the second storage section 521 through the pipe 523.

The pipe 524 has an end connected to the outlet of the positive electrode compartment 620 and another end connected to the inlet of the second storage section 521. The second liquid 120 is fed to the second storage section 521 from the positive electrode compartment 620 through the pipe 524.

The pump 525 is disposed in the pipe 524. The pump 525 may be disposed in the pipe 523. The pump 525 pressurizes, for example, the second liquid 120. The flow rate of the second liquid 120 can be regulated by controlling the pump 525. The circulation of the second liquid 120 can be started or stopped with the pump 525. Incidentally, the flow rate of the second liquid 120 can be regulated with a member other than a pump. The member is, for example, a valve.

As described above, the second circulation mechanism 520 can circulate the second liquid 120 between the positive electrode compartment 620 and the second storage section 521. According to the second circulation mechanism 520, the amount of the second liquid 120 that is in contact with the positive electrode active material 320 can be readily increased. The contact time between the second liquid 120 and the positive electrode active material 320 can also be increased. Therefore, the oxidation reaction and reduction reaction of the second redox species with the positive electrode active material 320 can be efficiently carried out.

Next, an example of the operation of the redox flow battery 1000 is described. In the description below, the first redox species is referred to as “Md” in some cases. The negative electrode active material 310 is referred to as “NA” in some cases. In the description below, the second redox species used is tetrathiafulvalene (hereinafter referred to as “TTF” in some cases). The positive electrode active material 320 used is lithium iron phosphate (LiFePO₄). In the description below, the metal ions are lithium ions.

### Charge Process of Redox Flow Battery

First, a voltage is applied between the negative electrode 210 and positive electrode 220 of the redox flow battery 1000, whereby the redox flow battery 1000 is charged. Reactions on the negative electrode 210 side and reactions on the positive electrode 220 side in a charge process are described below.

### Reactions on Negative Electrode Side

Electrons are supplied to the negative electrode 210 from outside the redox flow battery 1000 by application of a voltage. This allows the first redox species contained in the first liquid 110 to be reduced on a surface of the negative electrode 210. The reduction reaction of the first redox species is represented by, for example, a reaction equation below. Incidentally, lithium ions (Li⁺) are supplied from, for example, the second liquid 120 through the metal ion-conducting membrane 400.

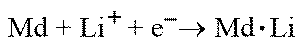

In the above reaction equation, Md·Li is a composite of a lithium cation and the reduced first redox species. The reduced first redox species contains an electron solvated with the first nonaqueous solvent in the first liquid 110. As the reduction reaction of the first redox species proceeds, the concentration of Md· Li in the first liquid 110 increases. The increase in the concentration of Md· Li in the first liquid 110 reduces the potential of the first liquid 110. The potential of the first liquid 110 is reduced to a value less than the maximum potential at which the negative electrode active material 310 can store lithium ions.

Next, Md·Li is fed to the negative electrode active material 310 by the first circulation mechanism 510. The potential of the first liquid 110 is lower than the maximum potential at which the negative electrode active material 310 can store lithium ions. Therefore, the negative electrode active material 310 receives a lithium ion and an electron from Md—Li. This oxidizes the first redox species and reduces the negative electrode active material 310. This reaction is represented by, for example, a reaction equation below. Incidentally, in the reaction equation below, s and t are an integer of greater than or equal to 1.

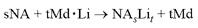

In the above reaction equation, NAₛLiₜ is a lithium compound formed by the fact that the negative electrode active material 310 stores lithium ions. When the negative electrode active material 310 contains graphite, s and t in the above reaction equation are, for example, 6 and 1, respectively. In this case, NAₛLiₜ is C₆Li. When the negative electrode active material 310 contains aluminum, tin, or silicon, s and t in the above reaction equation are, for example, 1. In this case, NAₛLiₜ is LiAl, LiSn, or LiSi.

Next, the first redox species oxidized by the negative electrode active material 310 is fed to the negative electrode 210 by the first circulation mechanism 510. The first redox species fed to the negative electrode 210 is reduced on a surface of the negative electrode 210 again. This produces Md—Li. As described above, the negative electrode active material 310 is charged by the circulation of the first redox species. That is, the first redox species functions as a charge mediator.

### Reactions on Positive Electrode Side

The second redox species is oxidized on a surface of the positive electrode 220 by application of a voltage. This allows electrons to be drawn from the positive electrode 220 to outside the redox flow battery 1000. The oxidation reaction of the second redox species is represented by, for example, reaction equations below.

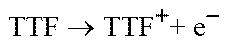

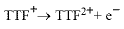

Next, the second redox species oxidized on the positive electrode 220 is fed to the positive electrode active material 320 by the second circulation mechanism 520. The second redox species fed to the positive electrode active material 320 is reduced by the positive electrode active material 320. On the other hand, the positive electrode active material 320 is oxidized by the second redox species. The positive electrode active material 320 oxidized by the second redox species releases lithium ions. This reaction is represented by, for example, a reaction equation below.

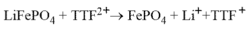

Next, the second redox species reduced by the positive electrode active material 320 is fed to the positive electrode 220 by the second circulation mechanism 520. The second redox species fed to the positive electrode 220 is oxidized on a surface of the positive electrode 220 again. This reaction is represented by, for example, a reaction equation below.

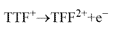

As described above, the positive electrode active material 320 is charged by the circulation of the second redox species. That is, the second redox species functions as a charge mediator. Lithium ions (Li⁺) generated by the charge of the redox flow battery 1000 move to, for example, the first liquid 110 through the metal ion-conducting membrane 400.

### Discharge Process of Redox Flow Battery

In the redox flow battery 1000, electricity can be drawn from the negative electrode 210 and the positive electrode 220. Reactions on the negative electrode 210 side and reactions on the positive electrode 220 side in a discharge process are described below.

### Reactions on Negative Electrode Side

The first redox species is oxidized on a surface of the negative electrode 210 by the discharge of the redox flow battery 1000. This allows electrons to be drawn from the negative electrode 210 to outside the redox flow battery 1000. The oxidation reaction of the first redox species is represented by, for example, a reaction equation below.

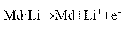

As the oxidation reaction of the first redox species proceeds, the concentration of Md·Li in the first liquid 110 decreases. The decrease in the concentration of Md·Li in the first liquid 110 increases the potential of the first liquid 110. This allows the potential of the first liquid 110 to exceed the equilibrium potential of NAₛLiₜ.

Next, the first redox species oxidized on the negative electrode 210 is fed to the negative electrode active material 310 by the first circulation mechanism 510. When the potential of the first liquid 110 is above the equilibrium potential of NAₛLiₜ, the first redox species receives a lithium ion and an electron from NAₛLiₜ. This reduces the first redox species and oxidizes the negative electrode active material 310. This reaction is represented by, for example, a reaction equation below. Incidentally, in the reaction equation below, s and t are an integer of greater than or equal to 1.

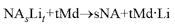

Next, Md·Li is fed to the negative electrode 210 by the first circulation mechanism 510. Md—Li fed to the negative electrode 210 is oxidized on a surface of the negative electrode 210 again. As described above, the negative electrode active material 310 is discharged by the circulation of the first redox species. That is, the first redox species functions as a discharge mediator. Lithium ions (Li⁺) generated by the discharge of the redox flow battery 1000 move to, for example, the second liquid 120 through the metal ion-conducting membrane 400.

### Reactions on Positive Electrode Side

Electrons are supplied to the positive electrode 220 from outside the redox flow battery 1000 by the discharge of the redox flow battery 1000. This allows the second redox species to be reduced on a surface of the positive electrode 220. The reduction reaction of the second redox species is represented by, for example, reaction equations below.

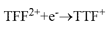

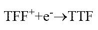

Next, the second redox species reduced on the positive electrode 220 is fed to the positive electrode active material 320 by the second circulation mechanism 520. The second redox species fed to the positive electrode active material 320 is oxidized by the positive electrode active material 320. On the other hand, the positive electrode active material 320 is reduced by the second redox species. The positive electrode active material 320 reduced by the second redox species stores lithium ions. This reaction is represented by, for example, a reaction equation below. Incidentally, lithium ions (Li⁺) are supplied from, for example, the first liquid 110 through the metal ion-conducting membrane 400.

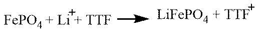

Next, the second redox species oxidized by the positive electrode active material 320 is fed to the positive electrode 220 by the second circulation mechanism 520. The second redox species fed to the positive electrode 220 is reduced on a surface of the positive electrode 220 again. This reaction is represented by, for example, a reaction equation below.

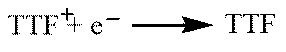

As described above, the positive electrode active material 320 is discharged by the circulation of the second redox species. That is, the second redox species functions as a discharge mediator.

### EXAMPLES

The present disclosure is further described below in detail with reference to examples. The present disclosure is not in any way limited to the examples. Many modifications can be made by those skilled in the art within the technical idea of the present disclosure.

### Preparation of First Liquid

A first liquid used was a lithium biphenyl solution containing biphenyl which is an aromatic compound that could be used as a first redox species and metallic lithium. The first liquid was prepared by a procedure below.

First, biphenyl and LiPF₆ which is an electrolyte salt were dissolved in triglyme which was a first nonaqueous solvent. The concentration of biphenyl in an obtained solution was 0.1 mol/L. The concentration of LiPF₆ in the solution was 1 mol/L. An excess of metallic lithium was added to the solution. Metallic lithium was dissolved up to a saturation level, whereby a dark-blue biphenyl solution saturated with lithium was obtained. The concentration of biphenyl in the biphenyl solution was 0.1 mol/L. An excess of metallic lithium remained in the form of a precipitate. Therefore, the first liquid used was a supernatant of the biphenyl solution.

### Preparation of Second Liquid

Tetrathiafulvalene which was a second redox species and LiPF₆ which was an electrolyte salt were dissolved in triglyme which was a second nonaqueous solvent. An obtained solution was used as a second liquid. The concentration of tetrathiafulvalene in the second liquid was 5 mmol/L. The concentration of LiPF₆ in the second liquid was 1 mol/L.

### Configuration of Evaluation System

As shown in FIG. 1, an electrochemical cell was configured. A metal ion-conducting membrane according to Example 1, Example 2, or Comparative Example 1 described below was used as a metal ion-conducting membrane in the electrochemical cell. Into the electrochemical cell, 1 mL of each of the first liquid and the second liquid was poured such that the first liquid and the second liquid were separated by the metal ion-conducting membrane. A negative electrode 210 was immersed in the first liquid 110 and a positive electrode 220 was immersed in the second liquid 120. The negative electrode 210 and the positive electrode 220 were made of SUS foam. The open circuit voltage of the electrochemical cell was measured for 40 hours using an electrochemical analyzer.

### Example 1

In a DMSO solution (FUJIFILM Wako Pure Chemical Corporation) containing 0.19 mol/L of sulfur trioxide (Tokyo Chemical Industry Co., Ltd.) and pyridine, 0.3 g of a regenerated cellulose film, Spectra/Por 4 (produced by Repligen Corporation (formerly Spectrum Laboratories, Inc.), the same chemical structure as that of natural cellulose, a molecular weight cutoff of 12,000 Da to 14,000 Da), was immersed. The immersed regenerated cellulose film was heated at 45° C. for five hours using a hotplate. The heated regenerated cellulose film was washed with ethanol. The washed regenerated cellulose film was immersed overnight in a liquid prepared by mixing a 1.0 mol/L aqueous solution of lithium hydroxide (Tokyo Chemical Industry Co., Ltd.) and ethanol at 50 wt%. Furthermore, the immersed regenerated cellulose film was washed with ethanol and was then vacuum dried at 50° C. overnight, whereby a metal ion-conducting membrane of Example 1 was obtained. For the sulfonation of the metal ion-conducting membrane, the amplification of spectrum intensity corresponding to S—O or S═O stretching vibration was confirmed by FT-IR measurement. In addition, the amplification of spectrum intensity corresponding to a —OH group was confirmed in the range of greater than or equal to 3,100 cm⁻¹ and less than or equal to 3,600 cm⁻¹ by FT-IR measurement.

### Example 2

A metal ion-conducting membrane of Example 2 was obtained under the same conditions as in Example 1 except that 0.16 mol/L of sulfur trioxide (Tokyo Chemical Industry Co., Ltd.) was used. For the sulfonation of the metal ion-conducting membrane, a peak corresponding to S—O or S═O stretching vibration was confirmed by FT-IR measurement. The amplification of spectrum intensity was confirmed. In addition, the amplification of spectrum intensity corresponding to a —OH group was confirmed in the range of greater than or equal to 3,100 cm⁻¹ and less than or equal to 3,600 cm⁻¹ by FT-IR measurement.

### Comparative Example 1

A regenerated cellulose film, Spectra/Por 3 (produced by Repligen Corporation (formerly Spectrum Laboratories, Inc.), the same chemical structure as that of natural cellulose, a molecular weight cutoff of 3,500 Da), was washed with pure water. The washed regenerated cellulose film was vacuum dried at 50° C. overnight, whereby a metal ion-conducting membrane of Comparative Example 1 was obtained.

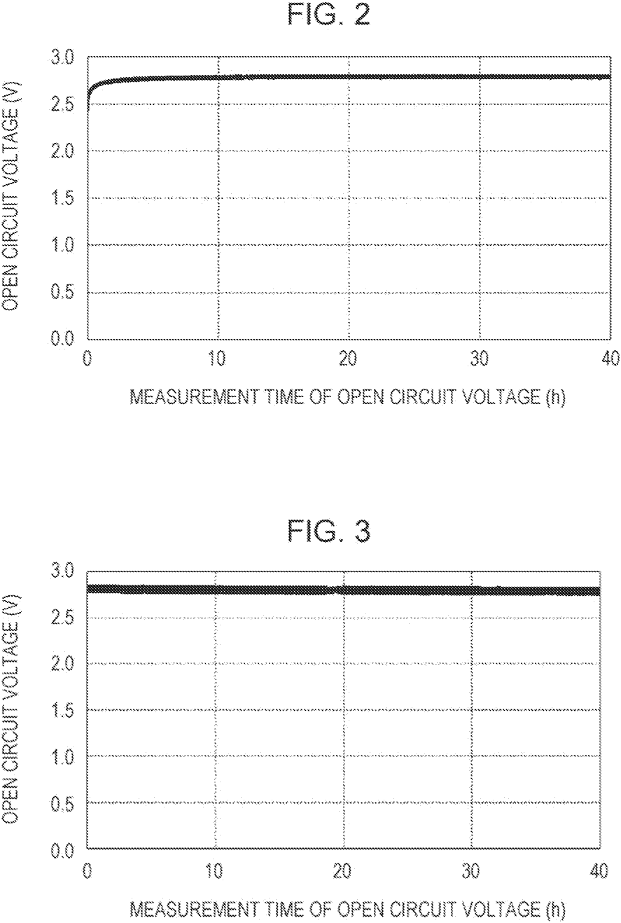

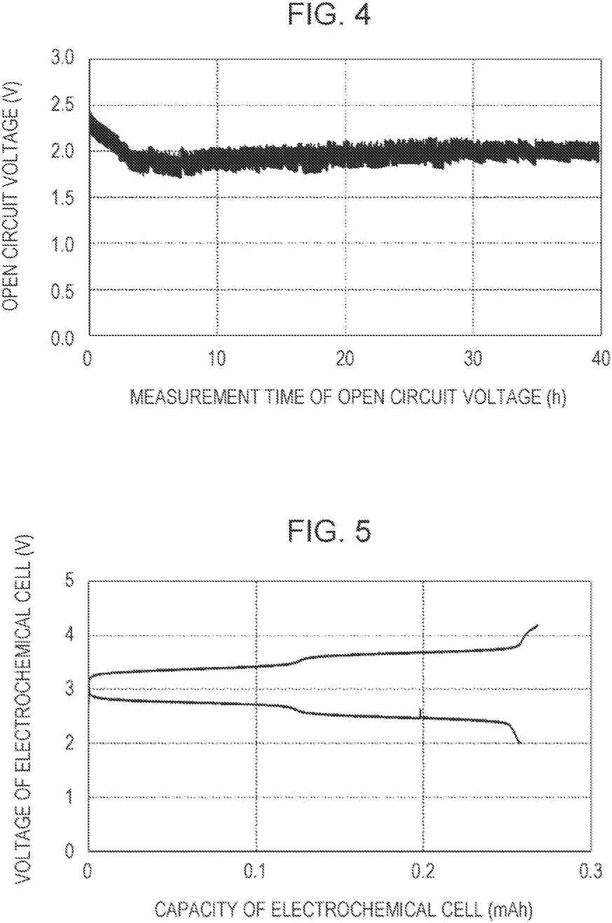

Each of FIGS. 2, 3, and 4 is a graph showing the open circuit voltage of an electrochemical cell according to a corresponding one of Example 1, Example 2, and Comparative Example 1. In FIGS. 2 to 4, the horizontal axis represents the time elapsed from the start of the measurement of the open circuit voltage (the measurement time of the open circuit voltage) and the vertical axis represents the open circuit voltage. For Examples 1 and 2, the temporal change in the open circuit voltage after ten cycles of charge and discharge is shown. For Comparative Example 1, the temporal change in the open circuit voltage after less than ten cycles of charge and discharge is shown. The electrochemical cell according to Comparative Example 1 was notably poor in ionic conductivity and it was difficult to charge or discharge the electrochemical cell according to Comparative Example 1.

Table 1 shows the reduction ΔV in open circuit voltage of the electrochemical cell according to Examples 1 and 2 and Comparative Example 1 shown in FIGS. 2 to 4. The reduction ΔV in open circuit voltage thereof is represented by the following equation:

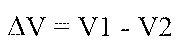

where V1 represents the maximum voltage in all data measured for 40 hours and V2 represents the voltage at the point in time after 40 hours had elapsed from the start of the measurement of the open circuit voltage.

Table 1

| | Reduction ΔV in open circuit voltage [mV] |
|---|---|
| Example 1 | 36.8 |
| Example 2 | 37.5 |
| Comparative Example 1 | 1,103 |

The electrochemical cells according to Examples 1 and 2 were such that the open circuit voltage thereof was stable over 40 hours after ten cycles of charge and discharge. This shows that, in the electrochemical cells according to Examples 1 and 2, the crossover of redox species is suppressed. On the other hand, it is clear that the electrochemical cell according to Comparative Example 1 is such that the open circuit voltage varies immediately after the assembly of the cell and thereafter the voltage fluctuates slightly. This shows that, in the electrochemical cell according to Comparative Example 1, the capability of suppressing crossover is low and the conductivity of Li ions is not good.

FIG. 5 is a graph showing the tenth-cycle charge/discharge profile of an electrochemical cell including the metal ion-conducting membrane according to Example 1. In FIG. 5, the horizontal axis represents the capacity of the electrochemical cell and the vertical axis represents the voltage of the electrochemical cell. The charge/discharge current was 50 µA and the cut-off voltage was set in the range of 2.0 V to 4.2 V.

As is clear from the graph in FIG. 5, battery operation is possible using a sample according to Example 1. The electrochemical cell including the metal ion-conducting membrane according to Example 1 exhibited a charge/discharge efficiency of 96.1% after ten cycles. This result suggests that the electrochemical cell including the metal ion-conducting membrane according to Example 1 has a high capability of suppressing crossover.

### Comparative Example 2

The crossover suppressibility of a metal ion-conducting membrane was investigated using an H-type cell (BAS Inc.) as an electrochemical cell. Details of cell configuration are described below.

### Preparation of First Liquid

A first liquid used was a lithium biphenyl solution containing biphenyl which is an aromatic compound that could be used as a first redox species and metallic lithium. The first liquid was prepared by a procedure below.

First, biphenyl and LiPF₆ which was an electrolyte salt were dissolved in 2-methyltetrahydrofuran which was a first nonaqueous solvent. The concentration of biphenyl in an obtained solution was 0.1 mol/L. The concentration of LiPF₆ in the solution was 1 mol/L. An excess of metallic lithium was added to the solution. Metallic lithium was dissolved up to a saturation level, whereby a dark-blue biphenyl solution saturated with lithium was obtained. The concentration of biphenyl in the biphenyl solution was 0.1 mol/L. An excess of metallic lithium remained in the form of a precipitate. Therefore, the first liquid used was a supernatant of the biphenyl solution.

### Preparation of Second Liquid

A solution prepared by dissolving LiPF₆ which is an electrolyte salt in 2-methyltetrahydrofuran which was a second nonaqueous solvent was used as a second liquid. The concentration of LiPF₆ in the second liquid was 1 mol/L.

### Preparation of Metal Ion-Conducting Membrane

A metal ion-conducting membrane used was one prepared by substituting hydrogen ions in Nafion 212 (Fuel Cell Store) with lithium ions. That is, a compound having a structure represented by a formula below was used. The preparation procedure was as described below. Nafion 212 was immersed overnight in a solution that was prepared such that the concentration of lithium hydroxide (Tokyo Chemical Industry Co., Ltd.) was 1.0 M and was heated at 80° C. for ten hours. Thereafter, the Nafion 212 was washed with pure water three times and was further heated in 80° C. pure water for one hour. Next, the Nafion 212 was dried at 80° C. overnight, whereby a metal ion-conducting membrane of Comparative Example 2 was obtained.

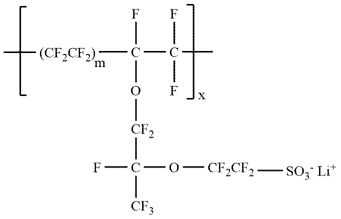

### Configuration of Evaluation System

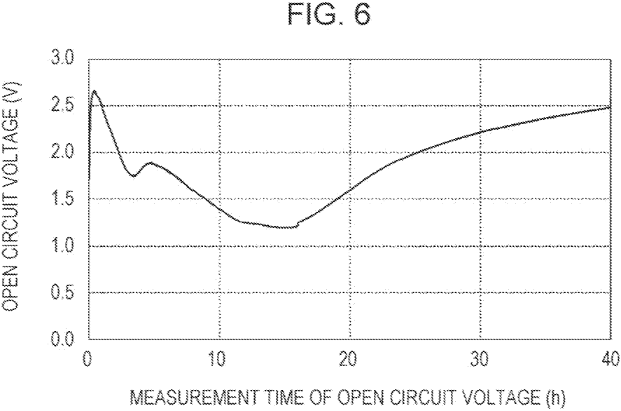

In the electrochemical cell shown in FIG. 1, the above-mentioned metal ion-conducting membrane of Comparative Example 2 was used as a metal ion-conducting membrane. Into the electrochemical cell, 1 mL of each of the first liquid and the second liquid was poured such that the first liquid and the second liquid were separated by the metal ion-conducting membrane. A negative electrode was immersed in the first liquid and a positive electrode was immersed in the second liquid. The negative electrode used was metallic lithium foil and the positive electrode used was surface-roughened copper foil. The open circuit voltage of the electrochemical cell was measured for 40 hours using an electrochemical analyzer. FIG. 6 is a graph showing the open circuit voltage of an electrochemical cell according to Comparative Example 2. In FIG. 6, the horizontal axis represents the time elapsed from the start of the measurement of the open circuit voltage (the measurement time of the open circuit voltage) and the vertical axis represents the open circuit voltage.

As is clear from the graph in FIG. 6, in the electrochemical cell according to Comparative Example 2, the open circuit voltage varies by about 1.5 V during measurement. This suggests that the concentration of a complex of biphenyl and lithium in the vicinity of the negative electrode decreased temporarily and then returned. That is, it is conceivable that biphenyl moved from the negative electrode side to the positive electrode side immediately after cell assembly because of the difference between the concentration of biphenyl in the first liquid and the concentration of biphenyl in the second liquid, such that the voltage decreased, and thereafter, biphenyl in the vicinity of the negative electrode dissolved metallic lithium to form a complex again, such that the voltage returned. That is, it is clear that, in the electrochemical cell according to Comparative Example 2, the crossover of redox species is not suppressed.

A redox flow battery according to the present disclosure can be satisfactorily used as, for example, an electricity storage device or an electricity storage system.

What is claimed is:

1. A redox flow battery comprising:
a negative electrode;
a positive electrode;
a first liquid which is in contact with the negative electrode, and which contains a first nonaqueous solvent, a first redox species, and metal ions;
a second liquid which is in contact with the positive electrode, and which contains a second nonaqueous solvent, a second redox species, and metal ions; and
a metal ion-conducting membrane disposed between the first liquid and the second liquid,
wherein the metal ion-conducting membrane contains an organic polymer containing a plurality of hydroxy groups, and
the organic polymer contains a group formed by substituting at least a portion of the hydroxy groups with a metal sulfonate.

2. The redox flow battery according to claim 1, wherein the organic polymer is cellulose or polyvinyl alcohol.

3. The redox flow battery according to claim 1, wherein the organic polymer is cellulose.

4. The redox flow battery according to claim 1, wherein the metal sulfonate is lithium sulfonate or sodium sulfonate.

5. The redox flow battery according to claim 1, wherein the metal ions include at least one selected from the group consisting of lithium ions, sodium ions, magnesium ions, and aluminum ions.

6. The redox flow battery according to claim 1, further comprising a negative electrode active material having at least a portion which is in contact with the first liquid,
wherein the first redox species is an aromatic compound,
the metal ions are lithium ions,
the first liquid dissolves lithium,
the negative electrode active material contains a substance having a property of storing and releasing the lithium ions,
a potential of the first liquid is less than or equal to 0.5 V vs. Li⁺/Li, and
the first redox species is oxidized or reduced by the negative electrode and is oxidized or reduced by the negative electrode active material.

7. The redox flow battery according to claim 6, wherein the aromatic compound includes at least one selected from the group consisting of biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, and benzil.

8. The redox flow battery according to claim 1, further comprising a positive electrode active material having at least a portion which is in contact with the second liquid,
wherein the second redox species is oxidized or reduced by the positive electrode and is oxidized or reduced by the positive electrode active material.

9. The redox flow battery according to claim 1, wherein the second redox species includes at least one selected from the group consisting of tetrathiafulvalene, metallocene compounds, triphenylamine, and derivatives thereof.

10. The redox flow battery according to claim 1, wherein each of the first nonaqueous solvent and the second nonaqueous solvent contains at least one of carbonate group-containing compounds or ether bond-containing compounds.

11. The redox flow battery according to claim 10, wherein the carbonate group-containing compounds include at least one selected from the group consisting of propylene carbonate, ethylene carbonate, dimethyl carbonate, ethyl methyl carbonate, and diethyl carbonate.

12. The redox flow battery according to claim 10, wherein the ether bond-containing compounds include at least one selected from the group consisting of dimethoxyethane, diethoxyethane, dibutoxyethane, diglyme, triglyme, tetraglyme, polyethylene glycol dialkyl ethers, tetrahydrofuran, 2-methyltetrahydrofuran, 2,5-dimethyltetrahydrofuran, 1,3-dioxolane, and 4-methyl-1,3-dioxolane.
